(19) United States
(12) Patent Application Publication
(10) Pub. No.: US 2024/0102909 A1
(43) Pub. Date: Mar. 28, 2024

(54) SETTLED DUST MEASUREMENT SYSTEM USING PHOTORESISTORS

(71) Applicant: Dust Company, Inc., Raleigh, NC (US)

(72) Inventors: Robert W. Baxter, Raleigh, NC (US); Derrick J. Hinkle, Louisburg, NC (US); Ralph E. Bard, Raleigh, NC (US); John N. Simpson, Raleigh, NC (US)

(21) Appl. No.: 18/476,518

(22) Filed: Sep. 28, 2023

Related U.S. Application Data
(60) Provisional application No. 63/377,419, filed on Sep. 28, 2022.

(51) Int. Cl. G01N 15/06; G01N 15/04; G08B 21/18

(52) U.S. Cl. CPC G01N 15/0612; G01N 15/04; G08B 21/182; G01N 2015/0096

(57) ABSTRACT

A method includes projecting light to obtain a reference measurement using a first photoresistor; collecting dust on a platform during a collection time interval; and projecting light across the platform to obtain a dust measurement using the first photoresistor or a second photoresistor.

### RELATED APPLICATION

The present application claims priority from and the benefit of U.S. Provisional Patent Application No. 63/377,419, filed Sep. 28, 2022. The disclosure of which is hereby incorporated herein by reference in its entirety.

### BACKGROUND

In recent years explosive dust, or combustible dust, has become a focus for agencies, such as OSHA, MSHA, NFPA, etc. Many rules and regulations are being written worldwide to address combustible dust situations. Searches for ‘combustible dust” or “dust explosion” typically turn up numerous records. The biggest efforts to date are being spent on preventative measures and hazard control. Preventive measures may include more housekeeping, general maintenance, and making sure that equipment is compatible with the area. Hazard control includes devices and/or systems to prevent or reduce the likelihood of an explosion, limit the damage it causes, or minimize the propagation of the explosion.

But increased house cleaning and maintenance may require more people and more equipment. Many locations in a facility are not safe or not easy to get to by a human. In some cases, equipment manufacturers have developed fans and other devices to help keep dust from building up on plant equipment or surfaces. The energy consumption of the large fans can be a big cost to the facility.

### SUMMARY

In some embodiments of the inventive concept, a method comprises: projecting light to obtain a reference measurement using a first photoresistor; collecting dust on a platform during a collection time interval; and projecting light across the platform to obtain a dust measurement using the first photoresistor or a second photoresistor.

In other embodiments, the method further comprises: comparing the dust measurement to the reference measurement generate a comparison result; and generating a notification when the comparison result satisfies a threshold.

In still other embodiments, the method further comprises: monitoring an input voltage of the first photoresistor; and generating a notification when the input voltage is determined to be outside a defined input voltage range.

In still other embodiments, the method further comprises: monitoring an input voltage of the first photoresistor; monitoring an input voltage of the second photoresistor; generating a notification when a fluctuation in the input voltage of the first photoresistor is determined to be outside a defined input voltage range; and generating a notification when the input voltage of the second photoresistor is determined to be outside the defined input voltage range.

In still other embodiments, the method further comprises: monitoring a conductivity of the first photoresistor in response to light; and adjusting an amount of light to which the first photoresistor is exposed when the conductivity is determined to be outside a defined conductivity range.

In still other embodiments, adjusting the amount of light comprises: adjusting one or more characteristics of the light projected across the platform; or adjusting an amount of ambient light to which the first photoresistor is exposed.

In still other embodiments, the method further comprises: monitoring a conductivity of the first photoresistor in response to light; monitoring a conductivity of the second photoresistor in response to the light; adjusting an amount of light to which the first photoresistor is exposed when the conductivity is determined to be outside a defined conductivity range; and adjusting an amount of light to which the second photoresistor is exposed when the conductivity is determined to be outside the defined conductivity range.

In still other embodiments, adjusting the amount of light to which the first and second photoresistors are exposed comprises: adjusting one or more characteristics of the light projected across the platform; or adjusting an amount of ambient light to which the first and second photoresistors are exposed.

In still other embodiments, the method further comprises: for each of the first photoresistor and the second photoresistor, measuring a conductivity of the respective photoresistor across a light range from low intensity to high intensity to generate a conductivity curve; using a machine learning model to perform curve fitting on the conductivity curves to generate a reference curve; and generating coefficients for each of the first photoresistor and the second photoresistor that map the respective conductivity curve for the respective photoresistor to the reference curve.

In still other embodiments, the method further comprises: normalizing the conductivity measurements based on respective input voltages of the first photoresistor and the second photoresistor that are used to generate the respective conductivity curves.

In still other embodiments, projecting light comprises projecting visible light.

In still other embodiments, projecting light comprises projecting invisible light.

In still other embodiments, the platform is retractable between a first position outside a measurement chamber and a second position inside the measurement chamber; and the platform is in the second position during the collection interval.

In some embodiments of the inventive concept, a system comprises a processor; and a memory coupled to the processor and comprising computer readable program code embodied in the memory that is executable by the processor to perform operations comprising: projecting light to obtain a reference measurement using a first photoresistor; collecting dust on a platform during a collection time interval; and projecting light across the platform to obtain a dust measurement using the first photoresistor or a second photoresistor.

In further embodiments, the operations further comprise: monitoring an input voltage of the first photoresistor; and generating a notification when the input voltage is determined to be outside a defined input voltage range.

In still further embodiments, the operations further comprise: monitoring an input voltage of the first photoresistor; monitoring an input voltage of the second photoresistor; generating a notification when a fluctuation in the input voltage of the first photoresistor is determined to be outside a defined input voltage range; and generating a notification when the input voltage of the second photoresistor is determined to be outside the defined input voltage range.

In still further embodiments, the operations further comprise: monitoring a conductivity of the first photoresistor in response to light; and adjusting an amount of light to which the first photoresistor is exposed when the conductivity is determined to be outside a defined conductivity range.

In still further embodiments, adjusting the amount of light comprises: adjusting one or more characteristics of the light projected across the platform; or adjusting an amount of ambient light to which the first photoresistor is exposed.

In still further embodiments, the operations further comprise: monitoring a conductivity of the first photoresistor in response to light; monitoring a conductivity of the second photoresistor in response to the light; adjusting an amount of light to which the first photoresistor is exposed when the conductivity is determined to be outside a defined conductivity range; and adjusting an amount of light to which the second photoresistor is exposed when the conductivity is determined to be outside the defined conductivity range.

In still further embodiments, the adjusting the amount of light to which the first and second photoresistors are exposed comprises: adjusting one or more characteristics of the light projected across the platform; or adjusting an amount of ambient light to which the first and second photoresistors are exposed.

Other methods, systems, computer program products and/or apparatus according to embodiments of the inventive concept will be or become apparent to one with skill in the art upon review of the following drawings and detailed description. It is intended that all such additional methods, systems, computer program products, and/or apparatus be included within this description, be within the scope of the present invention, and be protected by the accompanying claims. It is noted that aspects of the invention described with respect to one embodiment, may be incorporated in a different embodiment although not specifically described relative thereto. That is, all embodiments and/or features of any embodiment can be combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a dust measurement system according to some embodiments of the inventive concept;

FIGS. 2-4 are flowcharts that illustrates operations of the dust measurement system according to some embodiments of the inventive concept;

FIGS. 5 and 6 are graphs that illustrate generating coefficients to account for differences in receiver conductivity response in accordance with some embodiments of the inventive concept;

FIG. 7 is a flowchart that illustrates further embodiments of the dust measurement system according to some embodiments of the inventive concept;

FIG. 8 is a chart illustrating example dust measurements using an embodiment of the dust measurement system;

FIGS. 9-15 are diagrams that illustrate various example configurations of the dust measurement system according to some embodiments of the inventive concept;

FIG. 16 is a data processing system that may be used to implement the dust detection controller of FIG. 1 in accordance with some embodiments of the inventive concept; and

FIG. 17 is a block diagram that illustrates a software/hardware architecture for use in the dust detection controller of FIG. 1 in accordance with some embodiments of the inventive concept.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Some embodiments of the inventive concept stem realization that existing techniques to manage buildup of explosive or combustible dust in a facility may be expensive both in terms of human risk and/or effort as well as economic in terms of running mitigation equipment, such as fans.

Some embodiments of the inventive concept may provide systems and methods for calibrating and measuring the amount of settled dust on a platform surface using sensor or detector. The detection method may use an optical technique in which one or more optical transmitters are used as a light source, one or more optical receivers are used as reference sensors, and one or more optical receivers are used as dust sensors. In some embodiments the dust sensors may use self-referencing versus one or more separate and independent reference detectors. Unlike other techniques, measuring settled dust according to some embodiments of the inventive concept does not require the dust to be conductive, such as required in inductance techniques.

The light transmitters and sensors or detectors can be configured for visible and/or invisible light, such as infrared. The forms of light may be appropriately matched for type and frequencies. Whether the light source is visible or invisible affects the components used to implement the embodiments, but the overall functionality and methods remain the same for either type of light. For some applications, based on the properties of the settled dust, it may be desirable or undesirable to use either visible or invisible forms of light. It may also be desirable, for some applications, that both visible and invisible light sources be used to ensure proper measurement of the settled dust. Therefore, each dust measurement system according to some embodiments of the inventive concept may have one or more light sources and sensor or detector types based on the dust and application needs.

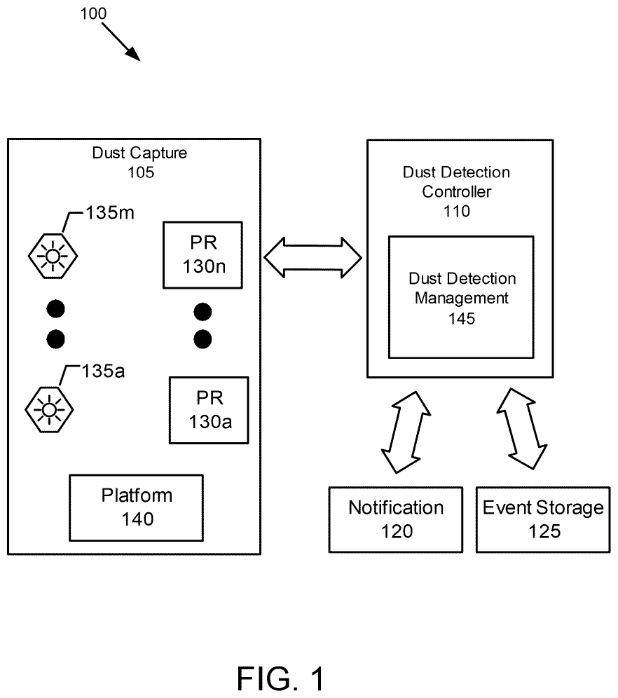

Referring now to FIG. 1, a dust measurement system 100 for measuring the amount of settled dust on a surface includes a dust capture apparatus 105 and a dust detection controller 110. The dust measurement system 100 can have hard wired communications and power or the communication can be wireless and the system may be battery powered in accordance with various embodiments. The dust detection controller 110 may communicate locally with control equipment for local control or notifications 120 and/or push data to a server 125 (edge or cloud) for long term storage, reporting and notifications. The settled dust information contained in a notification or alarm 120 can be used to inform local personnel that manual cleaning is required or to turn on automated cleaning equipment.

The dust capture apparatus 105 may comprise one or more photoresistors PR 130a, PR 130n, e.g., receivers or sensors, dust detectors. The dust capture apparatus 105 may use one or more receivers PR 130a, PR 130n as an independent reference detector or allow the dust receivers PR 130a, PR 130n to self-reference. A detector can include one or more individual receivers PR 130a, PR 130n or a cluster of receivers PR 130a, PR 130n wired in series, parallel, or a combination of series and parallel to obtain the desired operating response and range for their role as either dust detectors and/or reference detectors.

The dust capture apparatus 105 further comprises one or more light sources 135a, 135m, which may be configured to project light towards the receivers PR 130a, PR 130n. When measuring dust accumulation, the platform may be allowed to accumulate dust during a collection time interval and may be placed in between one or more of the light sources 135a, 135m and one or more of the receivers PR 130a, PR 130n. The dust detection controller 110 may include a dust detection management module 145, which can be used to manage the operation of the components of the dust capture apparatus 105 along with generating any notifications or alarms 120 based on the dust measurement results and posting of the measurement results via a notification 120 or to an event storage location 125. The dust detection management module 145 may generate a dust measurement based on the difference between the light received at a receiver PR 130a, PR 130n when projected through dust accumulated on the platform 140 and the light received at a receiver PR 130a, PR 130n used to obtain a reference measurement. A photoresistor increases in conductivity in response to increasing light intensity. Thus, measuring the conductivity of a PR 130a, PR 130n is representative on the amount or intensity of light being received thereon. Dust accumulation may reduce the amount or intensity of light projected onto a receiver PR 130a, PR 130n. This diminishment in light results in a diminished conductivity relative to a receiver PR 130a, PR 130n used to obtain an unobstructed reference measurement. Thus, a comparison or difference between the two measurements may be used to estimate a dust accumulation measurement and/or cause a notification or alarm to be generated when the comparison or difference satisfies a threshold. In some embodiments, the same one or more receivers PR 130a, PR 130n used to obtain the dust measurement may also be used to obtain the reference measurement. This may be termed self-referencing. If the dust capture apparatus 105 dust detectors are self-referencing PR 130a, PR 130n, a reference reading can be taken before and/or after the dust reading. Such a system may require that either the dust settling platform 140 surface and the receivers PR 130a, PR 130n be separated while taking the reference readings. Light sources 135a, 135m vary with changes in input voltage as well as deteriorate over time. These changes in the light source 135a, 135m could be perceived as dust build-up if they are not compensated for. Using a light separate receiving device PR 130a, PR 130n as a reference or designing the system so that the dust receiving sensors PR 130a, PR 130n self-reference themselves may allow the dust measurement system 100 to compensate changes in the light source.

The one or more reference receivers PR 130a, PR 130n may be mounted in a place so that dust does not settle on them. The one or more dust receivers PR 130a, PR 130n may be mounted where they are exposed directly to settling dust or behind a clear, opaque, or translucent surface or where the settling platform 140 surface can be moved between them and the light source.

The one or more dust receivers PR 130a, PR 130n or the settling platform 140 surface does not have to be level horizontally or perpendicular to the settling dust. The settled dust surface can be at any angle. In some embodiments an angled surface may be used if allows dust to settle on the surface in a representative manner and is not greater than the angle of repose for the material being monitored for.

If the one or more receivers PR 130a, PR 130n are inside a shroud/enclosure/housing, the dust measurement system 100 may allow dust to settle on the one or more receivers PR 130a, PR 130n or settling platform 140 surface in a normal and representative manner. It may have sufficient openings to allow dust to settle in a representative manner. If the collection platform 140 surface is outside an enclosure or shroud, then this may be less of a concern.

The light receivers PR 130a, PR 130n may have an output based on the incoming light and the input voltage to the element. To ensure stable readings, the input voltage may be monitored. All dust and reference readings may be normalized as a function or percentage of the input voltage for small fluctuations. Measurement readings may be aborted, and internal alarms may be generated when the input voltage fluctuations are large or the fluctuations are outside an acceptable range. This may improve the quality of the reported dust levels and ensure they are accurate.

Light receivers PR 130a, PR 130n, like all devices, have a limit on their response. The devices PR 130a, PR 130n may become saturated as the light source increases in intensity and will quit responding (changing in conductivity) no matter how much more the light intensifies above the saturation point. The same is true on the low end of the response curve. As the light intensity decreases, the receiver PR 130a, PR 130n may become less responsive at some low level of light and may not change as the intensity is decreased more. Therefore, the light source 135a, 135m may be controlled to ensure the detectors PR 130a, PR 130n are operating in a valid conductivity range. In accordance with different embodiments, the light intensity can be controlled by directly controlling the light source 135a, 135m or by blocking out a fixed light source by using an LCD shutter or light valve. Changes in ambient light may affect the dust readings. Thus, in some embodiments, light control may be managed to account for changes in ambient light. For example, the conductivity of a detector PR 130a, PR 130n may be monitored in response to light and the amount of light to which a detector PR 130a, PR 130n is exposed may be adjusted by, for example, blocking out some or as much ambient light as possible, controlling a light source within the measuring chamber, and/or by controlling the amount of light allowed into the measuring chamber.

The surface of the receiver PR 130a, PR 130n can be flat or angled depending on the application. The light source 135a, 135m can be near the receiver and does not need to be directly above the receiver. Having one or more light sources 135a, 135m directly above the one or more receivers PR 130a, PR 130n may not allow the dust to settle in a representative manner.

The dust detection management module 145 may be configured to manage the operation of the dust capture apparatus 105 including updating the parameters and coefficients associated with the one or more receivers PR 130a, PR 130n. The dust detection management module 145 may also manage an automated schedule for performing dust measurements and/or receiving manual prompts for performing an impromptu measurement. In some embodiments, the dust accumulation platform 140 may be moved between a dust collection position and a non-collection position. For example, the dust collection position may be inside a collection chamber while the non-collection position may be outside of the chamber.

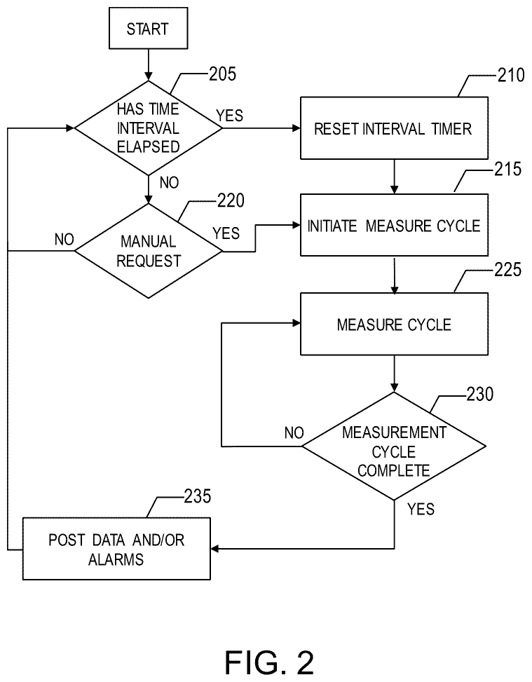

FIG. 2 is a flowchart that illustrates example operations in performing scheduled and impromptu dust measurement readings in accordance with some embodiments of the inventive concept. Operations begin at block 205 where a determination is made whether a time interval has elapsed. If so, then the time is reset at block 210 and a dust measurement cycle is initiated at block 215. Similarly, if a time interval has not elapsed, but a manual request is received at block 220, then a dust measurement cycle is initiated at block 215. The dust measurement is performed at block 225 until a determination is made at block 230 that the measurement cycle is complete. The measurement data and/or notifications and alarms may be posted at block 235.

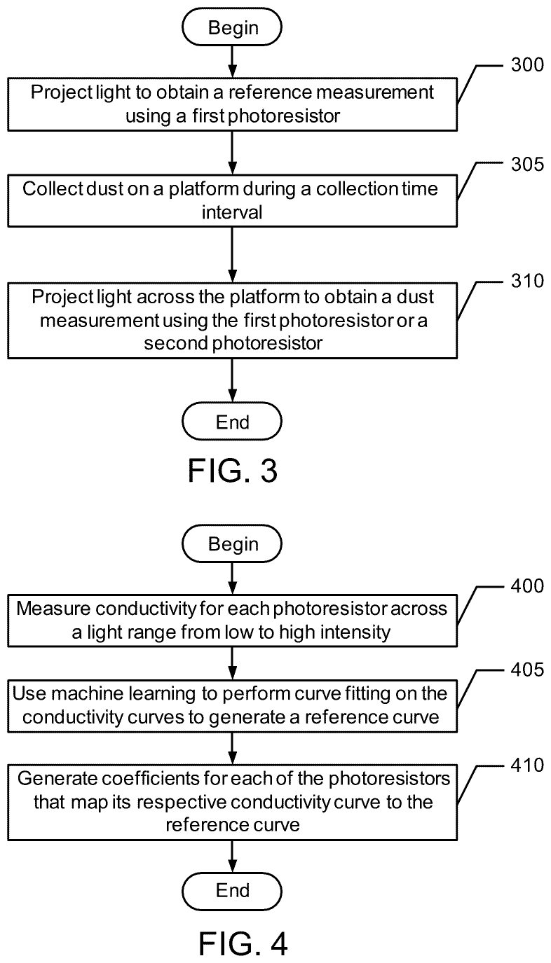

FIG. 3 is a flowchart that illustrates operations of the dust management system 100 according to some embodiments of the inventive concept. Operations begin at block 300 where light is projected to obtain a reference measurement using a first photoresistor. Dust is collected on a platform during a collection time interval at block 305. Light is projected across the platform to obtain a dust measurement using the first photoresistor or a second photoresistor at block 310.

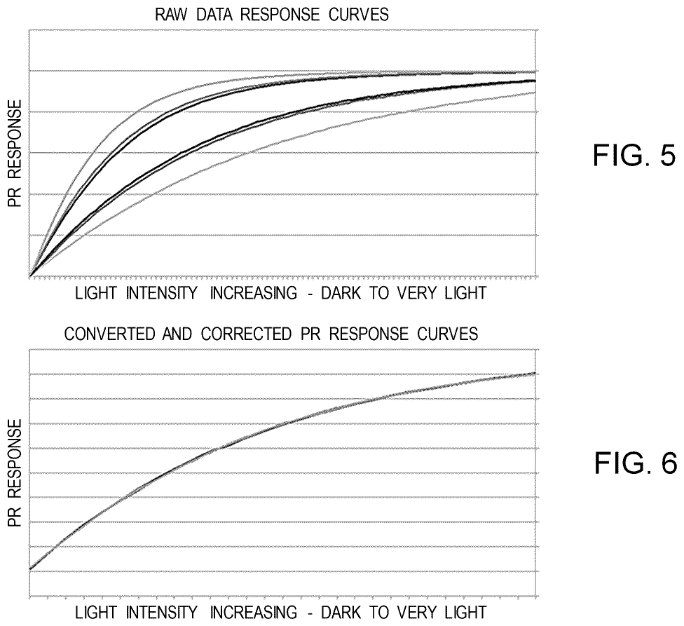

Because multiple receivers PR 130a, PR 130n may be used, these receivers PR 130a, PR 130n may be calibrated through coefficients so that their output measurement data is consistent with each other. Referring now to the flowchart of FIG. 4 and the graphs of FIGS. 5 and 6, operations begin at block 400 where the conductivity of each photoresistor is measured across a light range from low to high intensity. FIG. 5 illustrates an example where six different photoresistors had their conductivity measured across a light range from dark to very light. As shown in the graph, the conductivity increases with increasing light intensity, but the conductivity response of the six different varies significantly in the mid-range of light intensity. At block 405, a machine learning model can be used to perform curve fitting on the conductivity curves generated at block 400 to generate a reference curve as shown in FIG. 6. Coefficients may be generated for each of the photoresistors at block 410 that map the measurements for the photoresistor's respective conductivity curve to the reference curve. The dust detection management module 145 may be configured to apply these coefficients to the conductivity measurements obtained through the receivers PR 130a, PR 130n, which substantially accounts for differences in the conductivity response between the different receivers PR 130a, PR 130n. In some embodiments, before using the machine learning model at block 405 to generate the reference curve, the conductivity measurements from the different photoresistors may be normalized based on their respective input voltages.

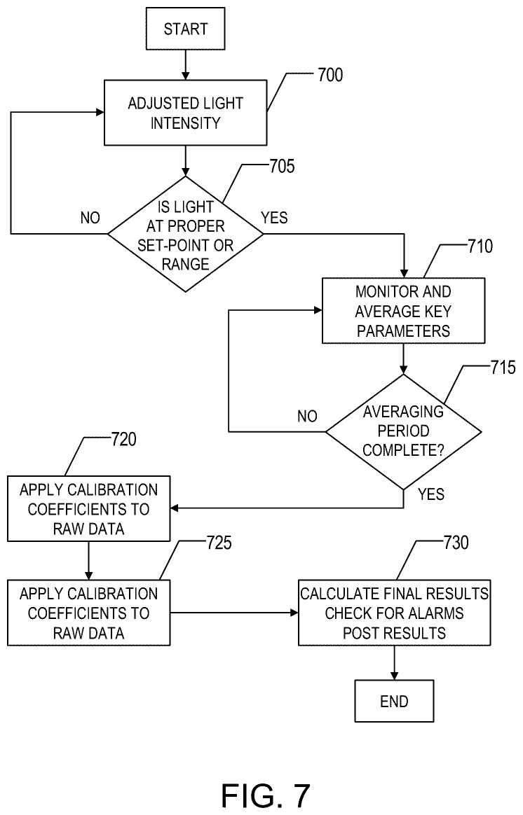

FIG. 7 is a flowchart that illustrates use of the coefficients in performing a dust measurement according to some embodiments of the inventive concept. Operations begin at blocks 700 and 705 where the light intensity is adjusted until the receivers PR 130a, PR 130n are inside a defined conductivity range. At blocks 710 and 715, conductivity measurements may be obtained from the receivers PR 130a, PR 130n and they may be averaged over one or more cycles. The calibration coefficients for the different receivers PR 130a, PR 130n may be applied to the raw data collected at blocks 710 and 715. The final results of the dust measurement process may be calculated at block 730 and any notifications or alarms may be generated, and results posted to the appropriate destinations.

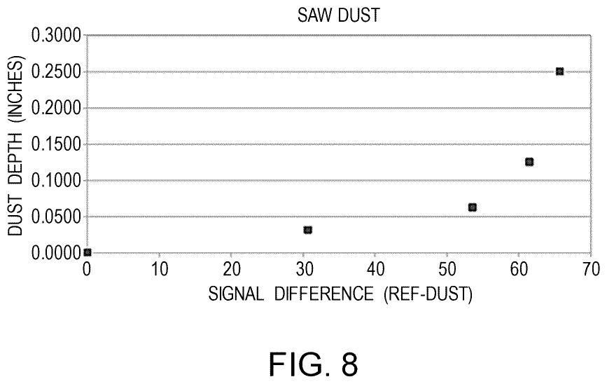

The different in response between the reference detectors and the dust detectors is an indication of increasing dust levels only. The actual depth of dust will be different for each dust type. An absolute depth measurement can be dependent on a number of independent parameters, such as particle size distribution, shape, etc., which affects the blockage of light. The FIG. 8 graph shows the results of sawdust from a test environment. The output is non-linear versus the depth of sawdust. This is due to the thicker depths resulting in light detection closer to the bottom ends of the monitoring range for the receivers.

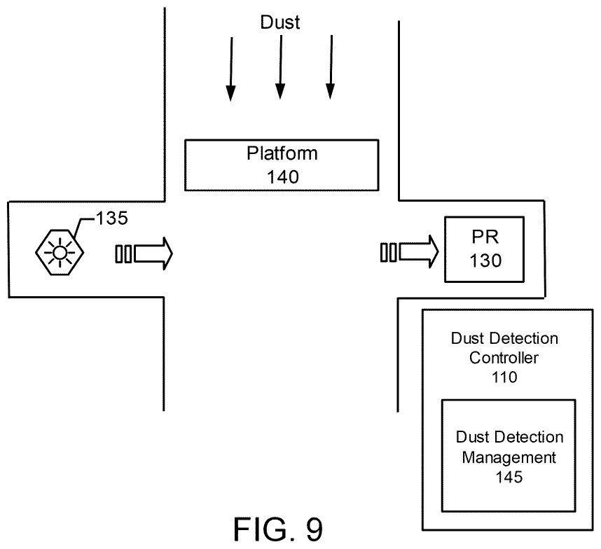

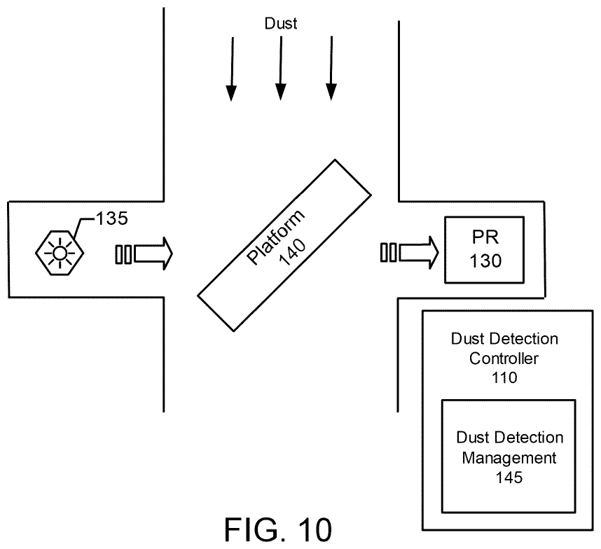

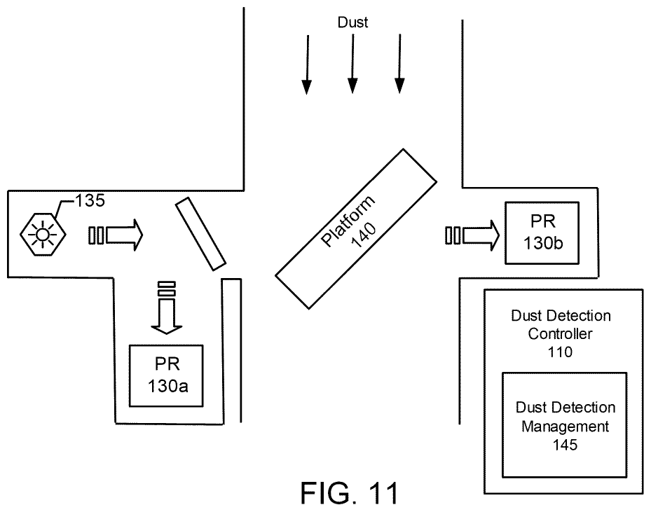

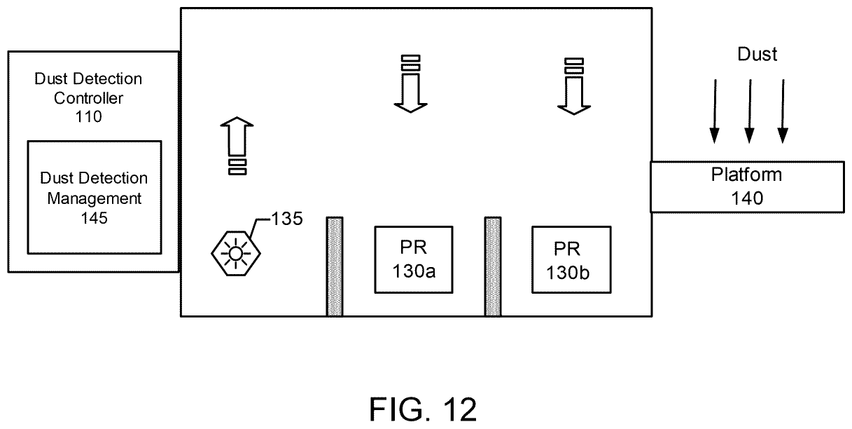

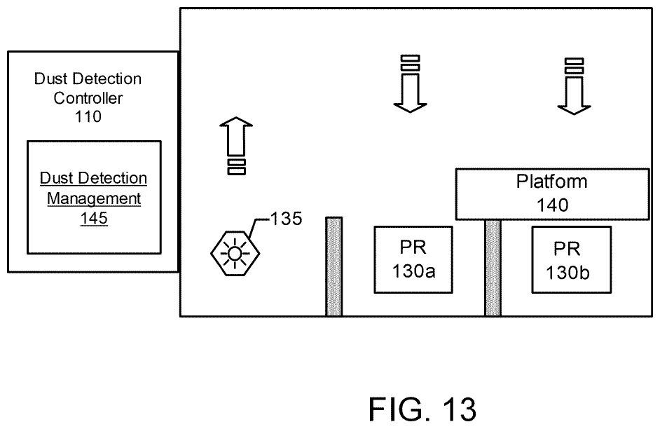

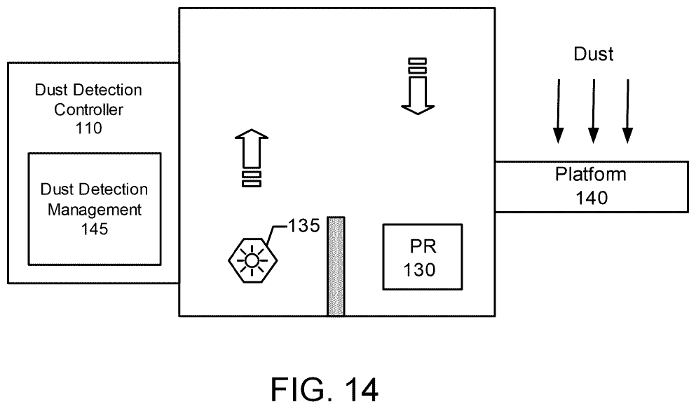

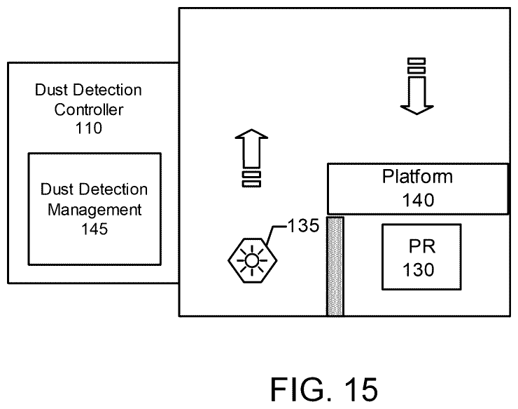

FIGS. 9-15 illustrate example configuration of the dust monitoring system according to various examples of the inventive concept. Referring to FIG. 9, a platform 140 is offset from the path between the light source 135 and receiver 130 allowing the receiver 130 to perform self-referencing. In FIG. 10, the platform 140 has been moved into the path between the light source 135 and the receiver 130 allowing a dust measurement operation to be performed. FIG. 11 is an example where the reference receiver 130a is different from the dust receiver 130b. The platform 140 may remain between the light source 135 and the dust receiver 130b to accumulate dust. The light reflector can be moved out of the way once the reference measurement using the reference receiver 130a is complete. FIG. 12 is an example in which the platform 140 is movable between a position outside a measurement chamber and inside a measurement chamber. Receiver 130a may be a reference receiver while receiver 130b may be a dust receiver. FIG. 13 illustrates the configuration of FIG. 12, but with the platform 140 moved to a position inside the chamber for performing a dust measurement operation using the receiver 130b. FIG. 14 is an example in which the platform 140 is movable between a position outside a measurement chamber and inside a measurement chamber. Receiver 130 may be a dust receiver in which self-referencing is performed. FIG. 15 illustrates the configuration of FIG. 14, but with the platform 140 moved to a position inside the chamber for performing a dust measurement operation using the receiver 130.

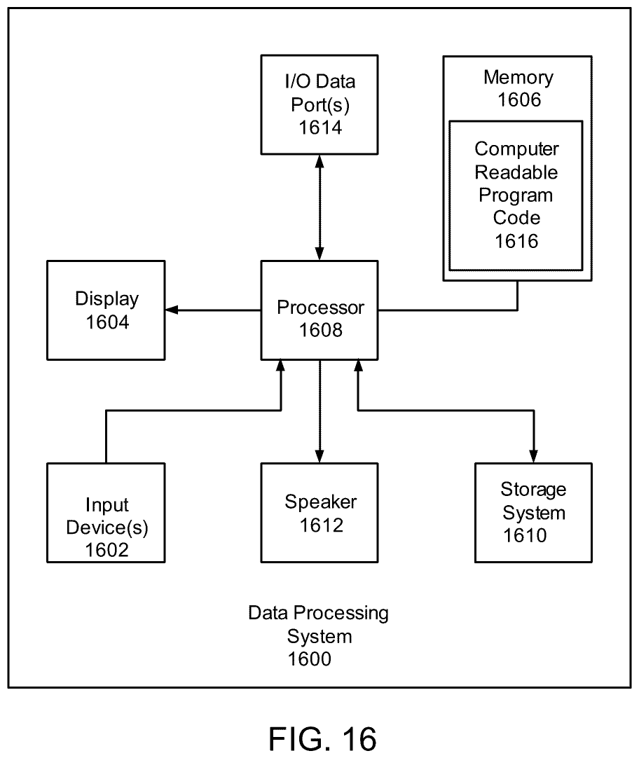

Referring now to FIG. 16, a data processing system 1600 that may be used to implement the dust detection controller 110 of FIG. 1, in accordance with some embodiments of the inventive concept, comprises input device(s) 1602, such as a keyboard or keypad, a display 1604, and a memory 1606 that communicate with a processor 1608. The data processing system 1600 may further include a storage system 1610, a speaker 1612, and an input/output (I/O) data port(s) 1614 that also communicate with the processor 1608. The processor 1608 may be, for example, a commercially available or custom microprocessor. The storage system 1610 may include removable and/or fixed media, such as floppy disks, ZIP drives, hard disks, or the like, as well as virtual storage, such as a RAMDISK. The I/O data port(s) 1614 may be used to transfer information between the data processing system 1600 and another computer system or a network (e.g., the Internet). The memory 1606 may be configured with computer readable program code 1616 to perform dust measurements using the dust measurement system 100 of FIG. 1.

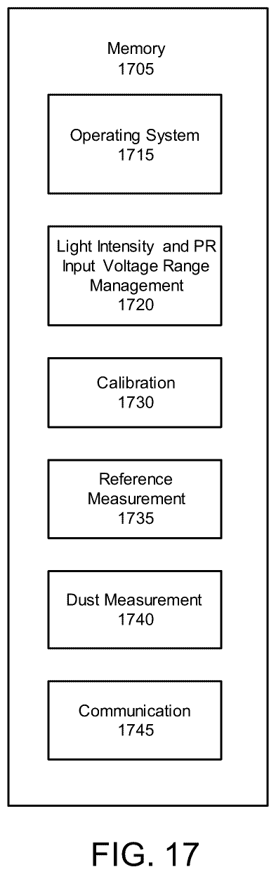

FIG. 17 illustrates a memory 1705 that may be used in embodiments of data processing systems, such as the dust detection controller 110 of FIG. 1 and the data processing system 1600 of FIG. 16, respectively, to evaluate the accumulation of dust in an environment and initiate mitigating action to clean or remove the dust if the dust has accumulated to problematic levels. The memory 1705 is representative of the one or more memory devices containing the software and data used for facilitating operations of the dust detection controller 110 as described herein. The memory 1705 may include, but is not limited to, the following types of devices: cache, ROM, PROM, EPROM, EEPROM, flash, SRAM, and DRAM.

As shown in FIG. 17, the memory 1705 may contain six or more categories of software and/or data: an operating system 1715, a light intensity and receiver input voltage range management module 1720, a calibration module 1730, a reference measurement module 1735, a dust measurement module 1740, and a communication module 1745. In particular, the operating system 1715 may manage the data processing system's software and/or hardware resources and may coordinate execution of programs by the processor. The light intensity and PR input voltage range management module 1720 may be configured to perform one or more of the operations described above with respect to FIGS. 1, 3, 4, and 7. The calibration module 1730 may be configured to perform one or more of the operations described above with respect to FIGS. 1, and 4-7. The reference measurement module may be configured to perform one or more of the operations described above with respect to FIGS. 1, 3, 7, and 9-15. The dust measurement module 1740 may be configured to perform one or more of the operations described above with respect to FIGS. 1, 3, 7, and 9-15. The communication module 1745 may facilitate communication between the dust detection controller 110 and the dust capture apparatus 105 and between the dust detection controller and any entity to which notifications, measurement results, alarms, and/or signals or messages to initiate mitigating action based on the accumulation of dust.

Although FIGS. 16 and 17 illustrate hardware/software architectures that may be used in data processing systems, such as the dust detection controller 110 of FIG. 1 in accordance with some embodiments of the inventive concept, it will be understood that the present invention is not limited to such a configuration but is intended to encompass any configuration capable of carrying out operations described herein.

Computer program code for carrying out operations of data processing systems discussed above with respect to FIGS. 1-17 may be written in a high-level programming language, such as Python, Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the dust measurement system 110 and the data processing system 1600 of FIG. 16 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

Thus, some embodiments of the inventive concept may provide a dust measurement system that is adaptable to the particular application in which it is deployed. The dust measurement system may use one or more light sources and may include one or more receivers for dust accumulation detection. The receivers may be monitored individually or connected in series, parallel, or a combination of both based on the final application needs.

Sensors can be configured to “wake up” periodically and conduct a test at a predetermined frequency or accept manual requests to conduct a test. Based on the configuration of the dust measurement system, the results may be sent to, for example, a local panel or to a cloud-based system, which allows users to view data. Both the automated measurement cycle and the manual measurement request operating modes may also provide alarms and event notifications based on user configured alarm limits and events.

Because different dust may have different receiver responses associated therewith based on changes in material, particle size, and density, the dust measurement system may allow the user to define and set the alarm level. The user may also be able to set the measurement cycle interval to meet their application needs.

The amount of light that will pass through a known layer of settled dust can be affected by different properties of the dust, such as shape, opacity, color, etc. Therefore, to get a more accurate indication of the dust depth for a specific application, on-site calibration using native dust may be performed to create a correction to the output reading of a standard or factory calibration.

The on-site calibration can be accomplished using depth guides. The slides may allow the user to create a known depth of settled dust. Best results may be obtained when the settled dust is physically similar to normal dust in the area versus being packed down or intentionally “fluffed.” Several levels may be recommended, but, in some embodiments, a guide that that is as close as possible to the alarm or action depth for the application may be used.

The standard or factory calibration references may include reference “slides” with known optical density. The reference slides may be configured to cover multiple points over the entire operating range of the system. The reference slides can be used periodically to as manual checks of the overall dust measurement or monitoring system.

Automatic QA checks may be configured in the system. These may be equivalent to “zero/span” checks and/or internal QA checks to confirm the functionality of internal components.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present disclosure of embodiments has been presented for purposes of illustration and description, but is not intended to be exhaustive or limited to the disclosure in the form disclosed. Many variations and modifications can be made to the embodiments without substantially departing from the principles of the present inventive concept. All such variations and modifications are intended to be included herein within the scope of the present inventive concept.

What is claimed is:

1. A method, comprising:
projecting light to obtain a reference measurement using a first photoresistor;
collecting dust on a platform during a collection time interval; and
projecting light across the platform to obtain a dust measurement using the first photoresistor or a second photoresistor.

2. The method of claim 1, further comprising:
comparing the dust measurement to the reference measurement generate a comparison result; and
generating a notification when the comparison result satisfies a threshold.

3. The method of claim 1, further comprising:
monitoring an input voltage of the first photoresistor; and
generating a notification when a fluctuation in the input voltage is determined to be outside a defined input voltage range.

4. The method of claim 1, further comprising;
monitoring an input voltage of the first photoresistor;
monitoring an input voltage of the second photoresistor;
generating a notification when the input voltage of the first photoresistor is determined to be outside a defined input voltage range; and
generating a notification when the input voltage of the second photoresistor is determined to be outside the defined input voltage range.

5. The method of claim 1, further comprising:
monitoring a conductivity of the first photoresistor in response to light; and
adjusting an amount of light to which the first photoresistor is exposed when the conductivity is determined to be outside a defined conductivity range.

6. The method of claim 5, wherein adjusting the amount of light comprises:
adjusting one or more characteristics of the light projected across the platform; or
adjusting an amount of ambient light to which the first photoresistor is exposed.

7. The method of claim 1, further comprising:
monitoring a conductivity of the first photoresistor in response to light;
monitoring a conductivity of the second photoresistor in response to the light;
adjusting an amount of light to which the first photoresistor is exposed when the conductivity is determined to be outside a defined conductivity range; and
adjusting an amount of light to which the second photoresistor is exposed when the conductivity is determined to be outside the defined conductivity range.

8. The method of claim 7, wherein adjusting the amount of light to which the first and second photoresistors are exposed comprises:
adjusting one or more characteristics of the light projected across the platform; or
adjusting an amount of ambient light to which the first and second photoresistors are exposed.

9. The method of claim 1, the method further comprising:
for each of the first photoresistor and the second photoresistor, measuring a conductivity of the respective photoresistor across a light range from low intensity to high intensity to generate a conductivity curve;
using a machine learning model to perform curve fitting on the conductivity curves to generate a reference curve; and
generating coefficients for each of the first photoresistor and the second photoresistor that map the respective conductivity curve for the respective photoresistor to the reference curve.

10. The method of claim 9, further comprising:
normalizing the conductivity measurements based on respective input voltages of the first photoresistor and the second photoresistor that are used to generate the respective conductivity curves.

11. The method of claim 1, wherein projecting light comprises projecting visible light.

12. The method of claim 1 wherein projecting light comprises projecting invisible light.

13. The method of claim 1, wherein the platform is retractable between a first position outside a measurement chamber and a second position inside the measurement chamber; and
wherein the platform is in the second position during the collection interval.

14. A system, comprising:
a processor; and
a memory coupled to the processor and comprising computer readable program code embodied in the memory that is executable by the processor to perform operations comprising:
projecting light to obtain a reference measurement using a first photoresistor;
collecting dust on a platform during a collection time interval; and
projecting light across the platform to obtain a dust measurement using the first photoresistor or a second photoresistor.

15. The system of claim 14, wherein the operations further comprise:
monitoring an input voltage of the first photoresistor; and
generating a notification when a fluctuation in the input voltage is determined to be outside a defined input voltage range.

16. The system of claim 14, wherein the operations further comprise;
monitoring an input voltage of the first photoresistor;
monitoring an input voltage of the second photoresistor;
generating a notification when the input voltage of the first photoresistor is determined to be outside a defined input voltage range; and
generating a notification when the input voltage of the second photoresistor is determined to be outside the defined input voltage range.

17. The system of claim 14, wherein the operations further comprise:
monitoring a conductivity of the first photoresistor in response to light; and
adjusting an amount of light to which the first photoresistor is exposed when the conductivity is determined to be outside a defined conductivity range.

18. The system of claim 17, wherein adjusting the amount of light comprises:
adjusting one or more characteristics of the light projected across the platform; or
adjusting an amount of ambient light to which the first photoresistor is exposed.

19. The system of claim 14, wherein the operations further comprise:
monitoring a conductivity of the first photoresistor in response to light;
monitoring a conductivity of the second photoresistor in response to the light;
adjusting an amount of light to which the first photoresistor is exposed when the conductivity is determined to be outside a defined conductivity range; and
adjusting an amount of light to which the second photoresistor is exposed when the conductivity is determined to be outside the defined conductivity range.

20. The system of claim 19, wherein adjusting the amount of light to which the first and second photoresistors are exposed comprises:
adjusting one or more characteristics of the light projected across the platform; or
adjusting an amount of ambient light to which the first and second photoresistors are exposed.
